(19) United States
(12) Patent Application Publication
(10) Pub. No.: US 2018/0314963 A1
(43) Pub. Date: Nov. 1, 2018

(54) DOMAIN-INDEPENDENT AND SCALABLE AUTOMATED PLANNING SYSTEM USING DEEP NEURAL NETWORKS

(71) Applicant: AIBrain Corporation, Seoul (KR)

(72) Inventor: Dániel László Kovács, Seoul (KR)

(21) Appl. No.: 15/956,396

(22) Filed: Apr. 18, 2018

Related U.S. Application Data
(60) Provisional application No. 62/487,404, filed on Apr. 19, 2017.

(51) Int. Cl. G06N 5/04; G06K 9/62; G06N 3/08; G06N 99/00

(52) U.S. Cl. CPC G06N 5/046; G06N 99/005; G06N 3/08; G06K 9/6264

(57) ABSTRACT

A specification of a problem using an artificial intelligence planning language is received. Machine learning features are determined using a computer processor and the specification of the problem. Using a trained machine learning model that is trained to approximate an automated planner and the determined machine learning features, a machine learning model result is determined. An action to perform is determined based on the machine learning model result.

### CROSS REFERENCE TO OTHER APPLICATIONS

This application claims priority to U.S. Provisional Patent Application No. 62/487,404 entitled BUILDING A DOMAIN-INDEPENDENT AND SCALABLE AUTOMATED PLANNING SYSTEM USING DEEP NEURAL NETWORKS filed Apr. 19, 2017 which is incorporated herein by reference for all purposes.

### BACKGROUND OF THE INVENTION

Automated artificial intelligence (AI) planners are capable of creating solutions that provide a sequence of actions and/or policies for achieving one or more goals from a provided initial state. Examples of these solutions include a sequence of actions for directing an unmanned aerial vehicle (AUV) to travel from one location to another. Individual actions may further include activities such as fueling, charging, exploration, cleaning, etc. AI planners can provide solutions not only for robotic and hardware agents but also for software agents including electronic commerce modules, web crawlers, intelligent personal computers, non-player characters in computer games, etc. However, solutions derived from automated planners are typically limited to a particular problem domain. Moreover, automated planners are traditionally resource intensive and only a limited number of automated planners can be run concurrently. Therefore, there exists a need for a lightweight AI planner that is domain independent and capable of running concurrently with many other instances of the AI planner.

### BRIEF DESCRIPTION OF THE DRAWINGS

Various embodiments of the invention are disclosed in the following detailed description and the accompanying drawings.

FIG. 1 is a flow diagram illustrating an embodiment of a process for creating a domain-independent automated planning system using neural networks.

FIG. 2 is a mixed functional and flow diagram illustrating an embodiment of a process for creating a domain-independent automated planning system using neural networks.

FIG. 3 is a flow diagram illustrating an embodiment of a process for training, testing, and validating data generated for an automated planning system using neural networks.

FIG. 4 is a mixed functional and flow diagram illustrating an embodiment of a process for training, testing, and validating data generated for an automated planning system using neural networks.

FIG. 5 is a flow diagram illustrating an embodiment of a process for training a machine learning model for an automated planning system.

FIG. 6 is a mixed functional and flow diagram illustrating an embodiment of a process for training a machine learning model for an automated planning system.

FIG. 7 is a flow diagram illustrating an embodiment of a process for applying a trained machine learning model for automated planning.

FIG. 8 is a mixed functional and flow diagram illustrating an embodiment of a process for applying a trained machine learning model for automated planning.

FIG. 9 is a functional diagram illustrating an embodiment of a domain-independent automated planning system using neural networks.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A domain-independent and scalable automated planning system using deep neural networks is disclosed. For example, an automated planning system is built by training a machine learning model, such as a deep neural network, using an automated planning system. An initial problem domain is first specified using a domain planning language. The domain specification is then parsed and using problem-set generator parameters, one or more problem sets corresponding to the domain are generated. Domain-specific features are extracted using the domain specification, generated problem sets, and extraction parameters to create training input vectors for a machine learning model. The domain specification and generated problem sets are solved using an automated planner. The first action from each solution plan is extracted and encoded to create output vectors that correspond to the input vectors. The input and output vectors are used as data sets to train, test, and validate the machine learning model. In some embodiments, a deep neural network (DNN) is utilized by encoding the input vector as a pixel-based image. In some embodiments, the DNN is a convolutional DNN (CDNN). Once trained, the machine learning model can be applied to artificial intelligence planning problems described by a domain and problem specification. Features of a problem are extracted using a domain specification, a problem specification, and extraction parameters, and provided as input to the trained machine learning model. The output result from the trained model is decoded to a domain-specific action and applied as the next action.

In various embodiments, a specification of a problem specified using an artificial intelligence (AI) planning language is received. For example, a problem specification using a Planning Domain Definition Language (PDDL) or Multi-Agent PDDL (MA-PDDL) specification can be received that describes an artificial intelligence (AI) planning problem. Using a computer processor, machine learning features are determined using the specification of the problem specified using the artificial intelligence planning language. For example, machine learning features are extracted based on a PDDL or MA-PDDL problem description. Using the determined machine learning features and a trained machine learning model, a machine learning model result is determined, wherein the machine learning model is trained to approximate an automated planner. For example, a machine learning model using a deep neural network (DNN) such as a convolutional DNN (CDNN) is created and trained using results from an automated AI planner. Results from applying the trained machine learning model approximate the results of the automated AI planner. Based on the machine learning model result, an action to perform is determined. For example, the machine learning result is translated to an action or policy that is performed. In various embodiments, the action or policy moves the state of the AI problem closer to the intended goal from an initial state.

Using the disclosed invention, a domain-independent, lightweight, scalable, deep neural network (DNN) based automated artificial intelligence (AI) planning solution can be provided for multiple application domains. The solution can be utilized to enhance the intelligence of an application, such as the intelligence of non-player characters (NPCs) in a game. In various embodiments, DNNs are utilized for domain-independent, automated AI planning. In various scenarios, automated, domain-independent, DNN-based AI planning allows for increased performance and requires reduced resources compared to traditional automated planning techniques. For example, using the disclosure automated AI planner solution, large numbers of DNN-based AI planners can run locally and simultaneously. For example, thousands of DNN-based AI planners can run simultaneously on resource (CPU, memory, etc.) limited devices. In some embodiments, the disclosed invention is implemented to run on mobile devices such as smartphones.

In various embodiments, enabling resource-limited devices, such as smartphones, with lightweight Artificial Intelligence (AI) planning capabilities, boosts the intelligence of the software (including the operating system and/or applications) running on the devices. In some embodiments, having a large number of fully autonomous AI planners can provide increased distributed computation such as a more realistic and more detailed city simulation.

In some embodiments, the disclosed invention provides an automated planning implementation that is scalable and application domain-independent by using deep neural networks (DNNs) including convolutional DNNs (CDNNs). In various embodiments, domain independence is achieved by utilizing an AI problem specification such as the Multi-Agent (MA) extension of the Planning Domain Definition Language (PDDL) specification to describe AI problems in a domain-independent fashion. In various embodiments, a domain-independent automated planner is applicable to more than one domain. For example, the planner may be applied to the game of Chess, Go, as well as additional domains including production-line scheduling for different forms of manufacturing. In contrast, the usefulness of automated planners that are limited to a single domain is severely restricted. Using a domain-independent approach, the disclosed invention may be applied to a wide variety of domains and is useful for a variety of applications including robot control, chatbots, and computer games, among others.

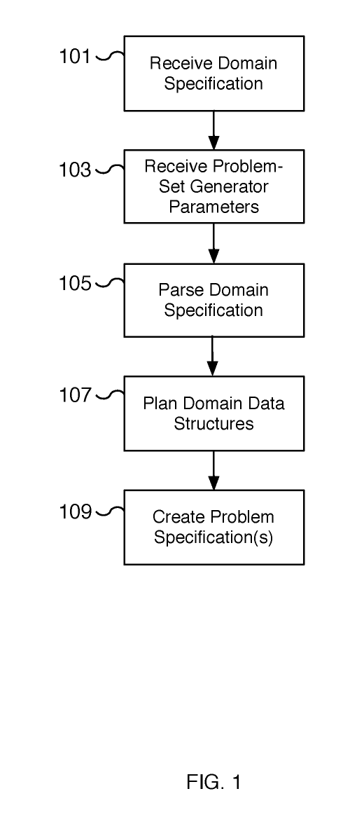

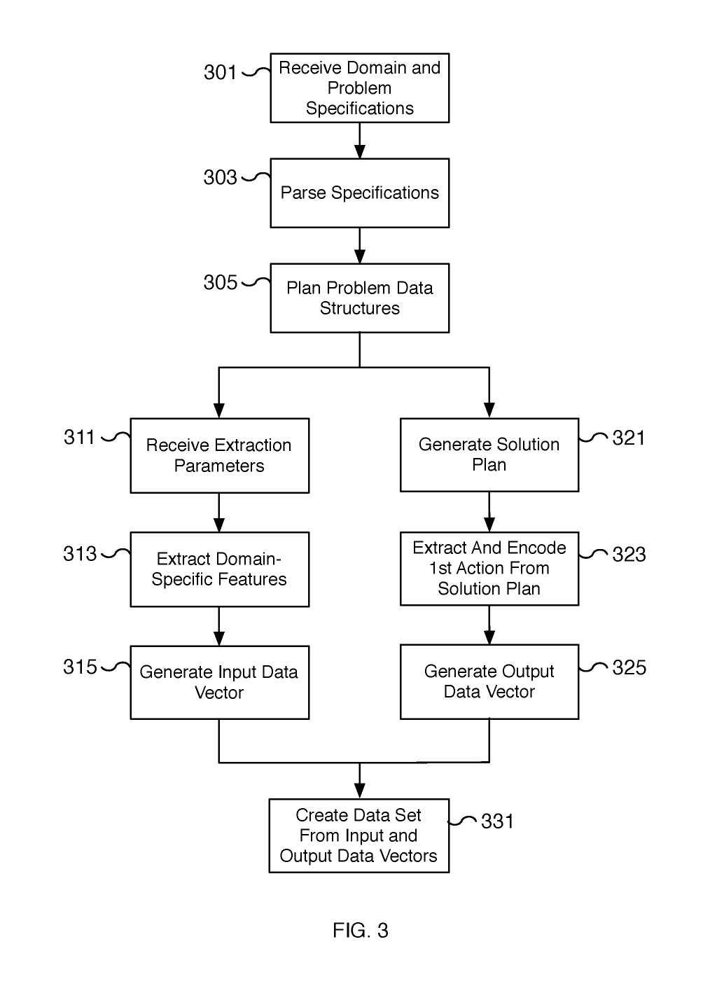

FIG. 1 is a flow diagram illustrating an embodiment of a process for creating a domain-independent automated planning system using neural networks. In the example, one or more problem specifications are created from a provided domain specification and problem generator parameters. The resulting problem specification(s) may be utilized to create an automated AI planning system, as described further with respect to FIG. 3. In various embodiments, the process of FIG. 1 may be performed while offline. For example, the process of FIG. 1 can be performed offline by a server such as a backend server and/or using cloud computing.

At 101, a domain specification is received. In some embodiments, a domain specification is described using a domain specification language (e.g., a version of the Planning Domain Definition Language (PDDL)). In various embodiments, the received domain specification corresponds to a domain model and may include a definition of the domain's requirements, object-type hierarchy, objects, predicates, functions and actions definitions, constraints and preferences, and/or derived predicate definitions, among other information.

At 103, problem-set generator parameters are received. In various embodiments, the problem-set generator parameters correspond to the domain specification received at 101. For example, problem-set generator parameters may include the number of problem specifications to generate, information regarding which portions of the domain specification should be considered, and/or information on how the different portions of the domain specification should be utilized, among other information.

At 105, the domain specification received at 101 is parsed. In some embodiments, the parser utilized is an artificial intelligence (AI) problem description parser. In some embodiments, the parser is a Planning Domain Definition Language (PDDL) parser. In various embodiments, the parser is based on the domain specification language.

At 107, domain data structures are planned. For example, the data structures necessary for creating one or more problem specifications are constructed based on the domain specification. For example, data structures are created that represent different possible actions, domain requirements, hierarchy of object-types, objects, predicates, functions, and/or actions that can have pre-conditions and/or effects (conditional or non-conditional, discrete or continuous, etc.). In some embodiments, the problem specifications correspond to one or more artificial intelligence (AI) problem descriptions. In some embodiments, the data structures are constructed based on a domain model of the domain specification.

At 109, one or more problem specifications are created. In some embodiments, an artificial intelligence (AI) problem specification is created. For example, a problem specification is created using a problem specification language such as a version of the Planning Domain Definition Language (PDDL). In various embodiments, each problem specification is created in accordance to the domain specification received at 101 and to the problem-set parameters received at 103. For example, a problem-set parameter defining the number of problem specifications to create is utilized to determine the number of final problem specifications created. In some embodiments, only a subset of the domain specification is utilized based on the generator parameters. In various embodiments, the final output is a set of AI problem specifications for the received domain specification. In some embodiments, the set of AI problem specifications correspond to a domain model. In some embodiments, each AI problem specification includes a set of objects, the initial state, desired goal(s), metrics, objective functions for metrics constraints, and/or preferences, among other information.

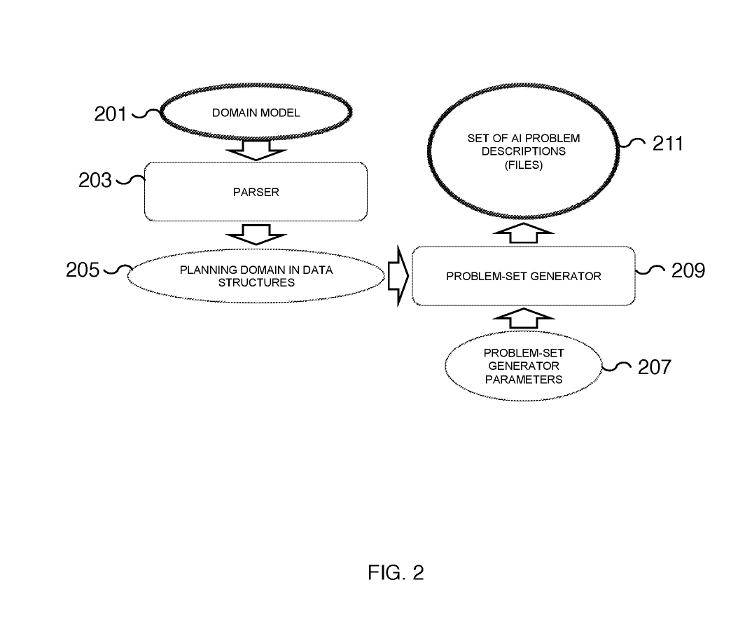

FIG. 2 is a mixed functional and flow diagram illustrating an embodiment of a process for creating a domain-independent automated planning system using neural networks. In various embodiments, FIG. 2 is an embodiment for generating a set of artificial intelligence (AI) problems specifications (e.g., Planning Domain Definition Language (PDDL) problems) for a given domain. In some embodiments, the domain can be represented using a PDDL description. At 201, a domain model is provided that describes the problem domain. At 203, a parser is utilized to parse a received domain model. In some embodiments, the domain model is described using a PDDL file such as a DOMAIN.PDDL file. At 205, domain data structures are planned. At 207, problem-set generator parameters are provided that control the generation of problem-sets. At 209, a problem-set generator takes as input the data structures and the problem-set generator parameters. The problem-set generator at 209 generates a set of problem specification files that are a set of problem descriptions corresponding to the problem domain. In some embodiments, the problem specification files are a set of PROBLEM.PDDL files.

In some embodiments, the domain model file at 201 is received at 101 of FIG. 1 and the problem-set generator parameters at 207 are received at 103 of FIG. 1. In some embodiments, the parser of 203 performs the step of 105 of FIG. 1. In some embodiments, the step 205 is performed at 107 of FIG. 1. In some embodiments, the problem-set generator of 209 performs the step of 109 of FIG. 1. In various embodiments, the set of problem specifications of 211 are created at the step of 109 of FIG. 1.

FIG. 3 is a flow diagram illustrating an embodiment of a process for training, testing, and validating data generated for an automated planning system using neural networks. In the example shown, the process of FIG. 3 utilizes domain and problem specifications to create training data using generated solution plans based on an automated planner. In some embodiments, the training data generated by the process of FIG. 3 utilizes the domain specification received at 101 of FIG. 1 and the problem specifications created at 109 of FIG. 1. In some embodiments, the training data generated by the process of FIG. 3 utilizes the domain specification and generated problem specifications of FIG. 2. In various embodiments, one or more training data points are created using one or more received problem specifications. For example, in various embodiments, the result of the process of FIG. 3 is a training dataset based on each problem specification created at 109 of FIG. 1. In various embodiments, the process of FIG. 3 may be performed while offline.

At 301, domain and problem specifications are received. For example, a domain specification is received and one or more problem specifications associated with the domain are received. In some embodiments, the problem specifications are generated automatically using the domain specification and problem generator parameters. In some embodiments, the specifications are described using a version of the Planning Domain Definition Language (PDDL). In some embodiments, the specifications are Multi-Agent PDDL (MA-PDDL) descriptions that include a domain description and a problem description.

At 303, the specifications received at 301 are parsed. For example, the domain specification received at 301 is parsed and each of the problem specifications received at 301 are parsed. In some embodiments, a parser is used that is capable of parsing Planning Domain Definition Language (PDDL) files. In various embodiments, the specifications are parsed into one or more internal data structures.

At 305, problem data structures are planned. In some embodiments, the planning problem data structures required by the domain and problem specifications are constructed. In some embodiments, the data structures are based on an artificial intelligence (AI) model specified. For example, planning problem data structures are created that represent different possible actions, domain requirements, hierarchy of object-types, objects, predicates, pre-conditions, effects, etc. Processing continues to 311 and 321. In some embodiments, the two different processing paths may be performed in parallel. In some embodiments, the processing is first performed along one path (e.g., steps 311, 313, and 315) and along a second path (e.g., 321, 323, and 325) before converging at step 331. In some embodiments, the order the paths are processed does not matter as long as the two paths converge at step 331.

At 311, extraction parameters are received. For example, extraction parameters are received that correspond to parameters used to extract domain-specific features. In some embodiments, extraction parameters include predicates, functions, additional domain models, problem description elements to include, the number of data-points that should be generated, and/or the resolution and/or structure of inputs, among other information.

At 313, domain-specific features are extracted. In some embodiments, the extraction is performed using a feature extractor. In some embodiments, the feature extractor is an imaginator module. In various embodiments, the feature extractor is specific to the domain and problem specifications received at 301 and extracts features from planning problem data structures. In various embodiments, the feature extractor extracts features based on the parameters provided at 311.

In some embodiments, an imaginator module is a module that takes an artificial intelligence (AI) problem specification (e.g. a Multi-Agent Planning Domain Definition Language (MA-PDDL) description of the domain and problem) as input and translates (e.g., encodes) it into a pixelated image. In various embodiments, an imaginator module generates a set of inputs for deep neural network (DNN) training. In various embodiments, the imaginator module provides the proper inputs for the machine learning model by encoding each AI problem. In various embodiments, the AI problems are continuously updated to reflect the current state of the environment and/or world.

At 315, an input data vector is generated. Using the features extracted at 313, an input vector is generated that will eventually be associated with an output vector. The generated input and associated output vector will be used to train, validate, and test a machine learning model. After generating the input data vector, processing continues to 331.

At 321, a solution plan is generated. In various embodiments, a solution plan is generated for each problem set by utilizing an automated planner. In some embodiments, an off-the-shelf automated planner is utilized. In some embodiments, the planning utilizes a Multi-Agent Planning Domain Definition Language (MA-PDDL) to describe the domain and problem set. In various embodiments, each solution plan is created and stored as a solution plan file. In some embodiments, the solution plan includes action plans.

At 323, the first action from each solution plan generated at 321 is extracted and encoded. In various embodiments, the encoding is based on the machine learning model. For example, in some embodiments, the first action from the solution plan (including a no-op action) is encoded into an output vector by assigning it the number of the neuron that is activated. For example, an activated neuron is assigned a value of 1 and an inactive neuron is assigned a value of 0. In various embodiments, the output vector corresponds to the output layer of a deep neural network (DNN) approximating the automated planner that generated the solution plan(s).

In some embodiments, the output vector is a one-hot vector. In various embodiments, a one-hot vector is a vector with all elements having the value 0 except for a single position that has the value 1. In the previous example, the output vector has values 0 for every element except for the element that corresponds to the designed action (or number). In various embodiments, the number of possible actions determines the length of the vector and the size of the output layer of the machine learning model.

In various embodiments, the output of the deep neural network (DNN) is interpreted. For example, in some embodiments, each output neuron of the DNN can set the probability for selecting the artificial intelligence (AI) action (e.g., a Planning Domain Definition Language (PDDL) action instance) associated to that neuron.

At 325, an output data vector is generated. Using the extracted and encoded first action from 323, an output vector is generated that will be associated with an input vector. The generated output and associated input vector will be used to train, validate, and test a machine learning model. After generating the output data vector, processing continues to 331.

At 331, a data set is created from the input data vector generated at 315 and the output data vector generated at 325. In various embodiments, the data set is a training corpus for training a machine learning model. In some embodiments, the data set is utilized to train, validate, and test the model. In some embodiments, the input vector is encoded as a pixel-based image. For example, a deep neural network (DNN) machine learning model may be utilized by encoding the input vector as an image and using the image as input to the DNN. In some embodiments, the DNN is a convolutional DNN (CDNN).

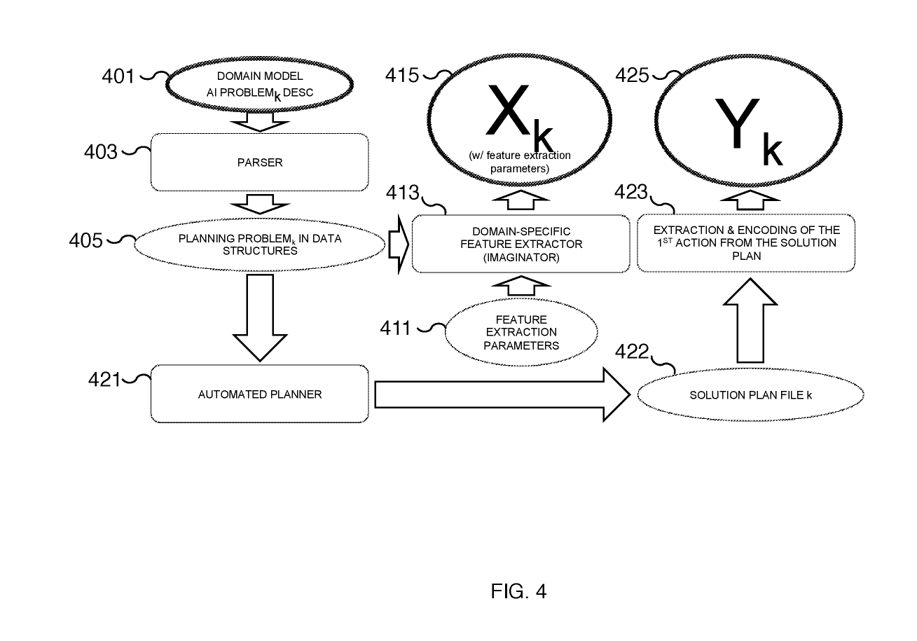

FIG. 4 is a mixed functional and flow diagram illustrating an embodiment of a process for training, testing, and validating data generated for an automated planning system using neural networks. In various embodiments, FIG. 4 describes a process and components for generating the training, test, and validation data for deep neural network (DNN) training. For example, a set of (Xk, Yk) data-points, where Xk and Yk are both vectors, for every k problem in the problem set, is generated using the process and components of FIG. 4.

At 401, a domain model and k number of artificial intelligence (AI) problem files are provided (e.g., AI problem-k description files). In some embodiments, the files utilize a Multi-Agent (MA) extension of the Planning Domain Definition Language (PDDL) specification for describing a planning problem in a domain-independent manner. At 403, a parser is utilized to parse the received domain model and AI problem-k descriptions. At 405, problem data structures are planned for each of the k problems corresponding to the problem descriptions. At 411, feature extraction parameters are provided. At 413, a domain-specific feature extractor is utilized to extract features from the k planning problem data structures. In some embodiments, the domain-specific feature extractor is an imaginator module. In some embodiments, an imaginator module is used to generate X-k inputs for deep neural network (DNN) training. At 415, a set of X-k data points is generated using the feature extraction parameters at 411 and the domain-specific feature extractor of 413. At 421, an automated planner is utilized to generate a solution to each of the domain and problem specifications. At 422, a solution plan file is generated for each problem file. In some embodiments, k solution plans are generated. At 423, the first action from each solution plan is extracted and encoded. At 425, a set of Y-k data points is generated from the extracted and encoded first actions of each solution file.

In some embodiments, the files provided at 401 are received at 301 of FIG. 3 and the feature extraction parameters provided at 411 are received at 311 of FIG. 3. In some embodiments, the parser of 403 performs the step of 303 of FIG. 3. In some embodiments, the step 405 is performed at 305 of FIG. 3. In some embodiments, the domain-specific feature extractor of 413 performs the step of 313 of FIG. 3. In some embodiments, the set of X-k data points generated at 415 is generated at 315 of FIG. 3. In some embodiments, the automated planner of 421 performs the step of 321 of FIG. 3 and the generated solution plan files of 422 are generated at step 321 of FIG. 3. In some embodiments, the step of 423 is performed at 323 of FIG. 3. In some embodiments, the set of Y-k data points generated at 425 is generated at 325 of FIG. 3. In some embodiments, each Y-k vector is a one-hot vector where each element has the value 0 except for the desired action that has the value 1. In various embodiments, the set of (Xk, Yk) data points is utilized to create a data set at step 331 of FIG. 3 and used for training, testing, and validating a machine learning model.

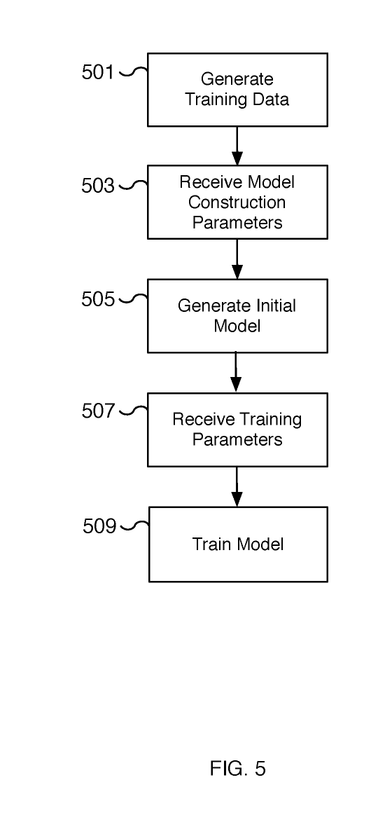

FIG. 5 is a flow diagram illustrating an embodiment of a process for training a machine learning model for an automated planning system. For example, a machine learning model is generated based on a desired machine learning structure and trained using specified training parameters. In some embodiments, the data corpus used to train the machine learning model is created using the process of FIG. 3 and/or using the process and components of FIG. 4. In some embodiments, the model is implemented using a deep neural network (DNN). In various embodiments, the process of FIG. 5 may be performed while offline.

At 501, training data is generated. In some embodiments, the training data is a set of input and output values. In various embodiments, the machine learning model is trained with the data set generated by the process of FIG. 3. For example, the data set of input and output vectors created at step 331 of FIG. 3 is used as the training data. In some embodiments, the training data is created using the process and components of FIG. 4.

At 503, model construction parameters are received. In various embodiments, machine learning model parameters are used to configure the construction of the model. For example, parameters may be used to specify the number of layers, the model size, the input size, and the output size, among other parameters. For example, deep neural network (DNN) parameters may be used to specify a model compatible with the training data generated at 501. In various embodiments, the input layer of the generated model is configured to receive generated images of the data set (e.g., the set of X-k data of 415 of FIG. 4) and the output layer of the DNN is configured to have the proper number of neurons as referenced by the output vector data (e.g., the set of Y-k data of 425 of FIG. 4). In various embodiments, the construction parameters specify the size of the input layer as the number of pixels in an input image when the images are provided to the generated model by systematically concatenating their lines.

At 505, an initial machine learning model is generated. Based on the construction parameters received at 503, the model is constructed. As described above, in some embodiments, the model is a neural network such as a deep neural network (DNN). Alternative machine learning models may also be used as appropriate. For example, in some embodiments, the machine learning model uses long-short term memory (LSTM) networks and/or recurrent neural networks (RNNs). In some embodiments, the type of neural network is a perception neural network such as a multi-layer perceptron (MLP) neural network. In some embodiments, the machine learning model uses a support vector machine (SVM) model.

At 507, training parameters are received. In various embodiments, the training parameters are used to configure the training of the model generated at 505. For example, training parameters may specify which subset of the training data is utilized for training, validation, and/or testing. In some embodiments, the training parameters include parameters for configuring the training algorithm. For example, parameters may include the number of epochs; the proportions of training, test, and validation data in the generated data-set; stop criteria; learning rate; and/or other appropriate hyperparameters.

At 509, the model generated is trained. For example, based on the parameters received at 507, the model generated at 505 is trained using the training data generated at 501. In some embodiments, the training includes validating and testing the trained model. In various embodiments, the result of step 509 is a trained machine learning model, such as a trained deep neural network (DNN) that approximates an automated artificial intelligence (AI) planner. In some embodiments, the automated AI planner that the DNN approximates is automated planner 421 of FIG. 4. In various embodiments, the training performed is supervised, offline training.

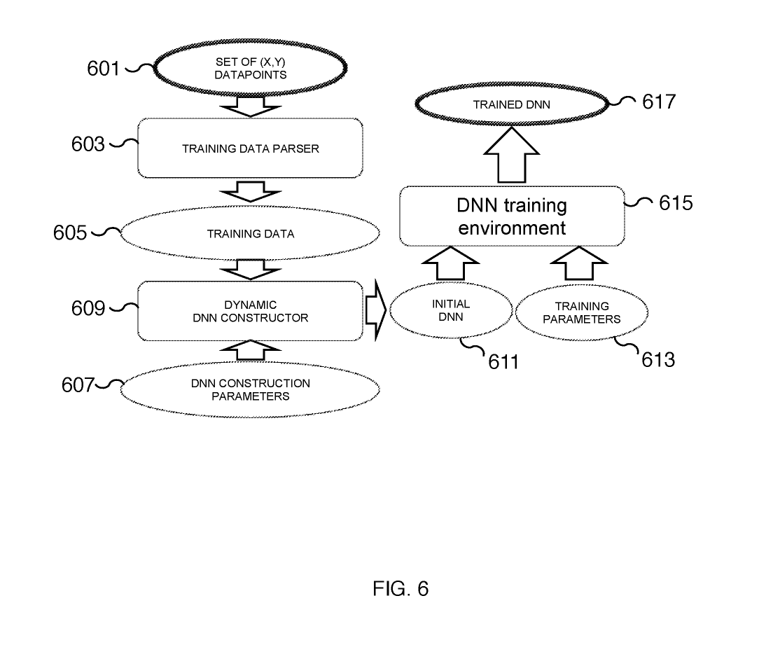

FIG. 6 is a mixed functional and flow diagram illustrating an embodiment of a process for training a machine learning model for an automated planning system. In the example shown, the machine learning model is a deep neural network (DNN). In some embodiments, the machine learning model is a convolutional DNN (CDNN). At 601, a set of (X, Y) data points is provided. In some embodiments, the data points are the data points generated by the process of FIG. 3 and/or the process and components of FIG. 4. At 603, a training data parser parses the received data points. At 605, training data is provided based on the parsing of the training data parser of 603. At 607, DNN construction parameters are provided. At 609, a dynamic DNN constructor generates an initial DNN using at least the DNN construction parameters of 607. At 611, an initial DNN is generated. At 613, training parameters are provided. At 615, a DNN training environment is utilized to train the initial DNN of 611 based on the initial DNN of 611 and the training parameters of 613. At 617, a trained DNN is produced.

In some embodiments, the set of (X, Y) data points of 601 and the training data of 605 are generated at 501 of FIG. 5 and the training data parser of 603 performs step 501 of FIG. 5. In some embodiments, the DNN construction parameters of 607 are received at 503 of FIG. 5. In some embodiments, the dynamic DNN constructor of 609 is used to perform step 505 of FIG. 5. In some embodiments, the training parameters of 613 are received at step 507 of FIG. 5 to generate the initial DNN of 611. In some embodiments, the DNN training environment of 615 performs step 509 of FIG. 5 using the initial DNN of 611 and the training parameters of 613. In some embodiments, the trained DNN of 617 is the result of step 509 of FIG. 5.

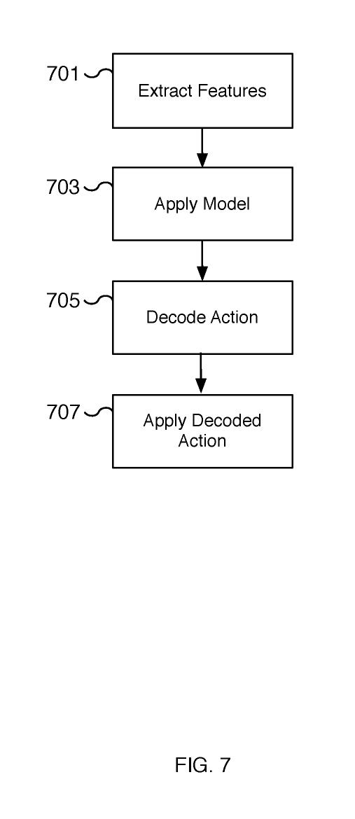

FIG. 7 is a flow diagram illustrating an embodiment of a process for applying a trained machine learning model for automated planning. In various embodiments, the process of FIG. 7 is performed while online and relies on the machine learning model trained using the process of FIG. 5 and/or the process and components of FIG. 6. In some embodiments, the process of FIG. 7 may be used for reactive planning for a given domain. For example, non-player characters (NPCs) may be controlled in a computer game using the process of FIG. 7. In some embodiments, the process of FIG. 7 is performed on a client for automated planning. For example, a client-side device such as a mobile device can implement automated planning using the process of FIG. 7 on a trained deep neural network (DNN). Unlike traditional automated artificial intelligence (AI) planners, the process of FIG. 7 allows for the creation of a lightweight planner that can run concurrently with many other planners. By utilizing a trained machine learning model, the automated AI planning is lightweight, more scalable, and requires fewer computational resources such as CPU cycles and memory. For example, multiple planners can run concurrently on a single device compared to traditional AI planning utilizing traditional planning techniques. In various embodiments, the process of FIG. 7 may be utilized to implement fully autonomous behavior for agents such as robots and non-player characters (NPCs) in a game.

In some embodiments, the process of FIG. 7 may be utilized by an autonomous vehicle to reach a desired goal, such as traveling from location A to location B. The vehicle autonomously plans its actions to achieve its goal of traveling from location A to location B. The plan may involve not only path-planning (i.e., planning of movement), but also planning other activities, such as fueling, oil-change, cleaning, charging, exploration, etc. As other examples, an Autonomous Underwater Vehicle (AUV), an Unmanned Aerial Vehicle (UAV), a deep-space spacecraft, and/or a planetary rover may perform a given task (e.g., achieve a goal or multiple goals) by scheduling and executing actions autonomously. Similarly, the process of FIG. 7 may be utilized not only for robotic and hardware agents but also for software agents including electronic commerce modules, web crawlers, intelligent personal computers, non-player characters in computer games, etc. The application of the process of FIG. 7 may be utilized to determine the appropriate action for each step of the solution needed to reach a particular artificial intelligence (AI) planning goal.

At 701, features are extracted. For example, domain-specific features are extracted from planning problem data structures. In various embodiments, the planning problem data structures represent a particular artificial intelligence (AI) planning problem. In some embodiments, the problem is specified using a domain and problem specification. For example, a domain and problem specification may be described using a Planning Domain Definition Language (PDDL) specification. In various embodiments, the planning problem data structures are constructed as described with respect to FIG. 3 and in particular with respect to steps 301, 303, and 305 of FIG. 3. For example, the planning problem data structures may be created by parsing a domain and problem specification. In various embodiments, the parsing of the specifications is performed only once for each set of specifications and the planning problem data structures are modified after the execution of each AI action, such as a PDDL action. In some embodiments, the problem is encoded using a Multi-Agent (MA) extension of PDDL that describes the planning problems in a domain-independent manner. At 701, the encoded MA-PDDL is decoded and features are extracted. In some embodiments, the problem is encoded as an AI model. The AI Model is decoded and features are extracted.

In various embodiments, the features are extracted as an input vector to a machine learning model. In various embodiments, the features are extracted as described with respect to FIG. 3 and in particular steps 311 and 313 of FIG. 3. For example, extraction parameters are received to configure the extraction of domain-specific features. In some embodiments, the features are extracted using an imaginator module as described above with respect to FIG. 3. In various embodiments, the imaginator module provides the proper inputs for the machine learning model by encoding each domain and problem description. In some embodiments, the features are extracted using the same framework relied on for training the model.

At 703, the trained machine learning model is applied. In some embodiments, the machine learning model is implemented using a deep neural network (DNN) and receives as input a pixel-based image. In some embodiments, the input image is a serialized image created by concatenating the rows of the image together. In various embodiments, the output result of 703 is an encoded action that can be applied to the current problem. In various embodiments, the application of the model approximates an automated artificial intelligence (AI) planner that relies on traditional AI planning techniques.

At 705, an action is decoded. For example, the action created as a result of applying the model at 703 is decoded. In various embodiments, the action is decoded into an artificial intelligence (AI) action, e.g. a Planning Domain Definition Language (PDDL) action. In some embodiments, a deep neural network (DNN) is utilized and the output of the DNN is translated back (e.g., decoded) into a parameterized action (e.g., sequence). In some embodiments, the output of the DNN may be a vector of floating point numbers, such as doubles, between 0.0 and 1.0. The action is selected based on the maximal output element of the DNN output vector. In some embodiments, the output selected requires that the respective grounded action is actually executable. In some embodiments, a grounded action may have parameters. In the event a grounded action has parameters, the parameters cannot be variables and must have a value. In various embodiments, all parameters must have a value and be executable in the world and/or environment. For example, a grounded action can be: MOVE FROM-HOME TO-WORK where MOVE is the action-name and FROM-HOME and TO-WORK are the values and/or the two parameters of the action. When executed, an agent such as a non-player character (NPC) moves from home to work.

At 707, the decoded action is applied. In various embodiments, the decoded action is a Planning Domain Definition Language (PDDL) action that is applied to the artificial intelligence (AI) planning problem. For example, the action may be to move an autonomous vehicle a certain distance. As another example, the action may be applied to a non-player character (NPC) in a computer game.

In various embodiments, once the action is applied at 707, the next action may be determined by repeating the process of FIG. 7 (not shown). In some embodiments, features may be extracted at 701 by modifying the planning problem data structures without the need to parse the specification files again (not shown). In some embodiments, the problem descriptions are continuously updated to reflect the current state (not shown).

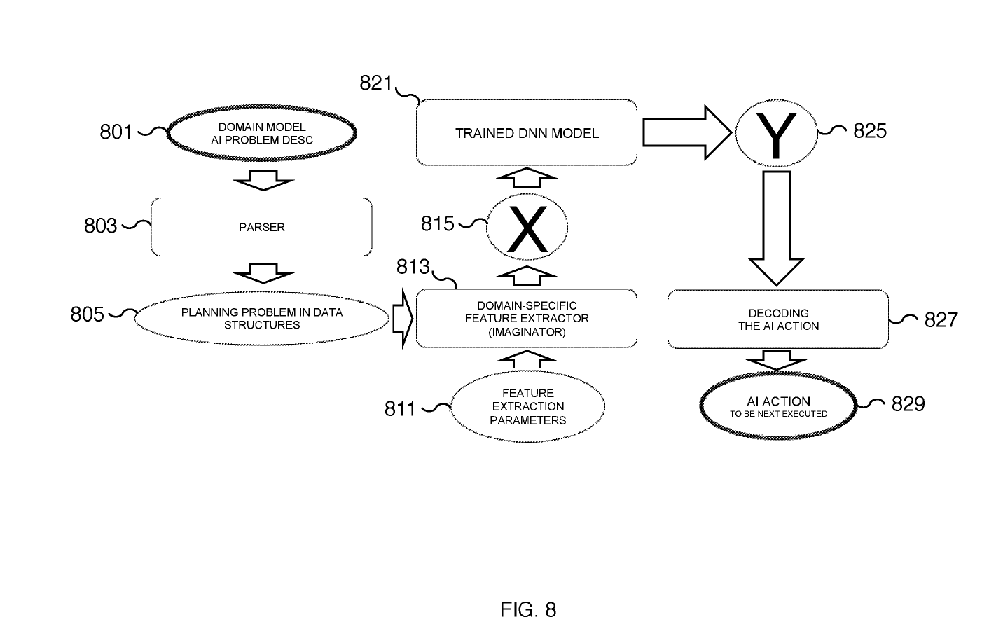

FIG. 8 is a mixed functional and flow diagram illustrating an embodiment of a process for applying a trained machine learning model for automated planning. In various embodiments, the process of FIG. 8 is performed while online. For example, the process of FIG. 8 is performed in real-time to determine the next action of a non-playing character (NPC) in a game. In various embodiments, the trained deep neural network (DNN) used in FIG. 8 is the trained deep neural network (DNN) of FIG. 6.

At 801, a domain model and an artificial intelligence (AI) problem description are provided. In some embodiments, the files are domain and problem specifications described using the Planning Domain Definition Language (PDDL) specification. At 803, a parser is utilized to parse a received domain model and AI problem description. In some embodiments, the parser at 803 is a PDDL parser. At 805, problem data structures are planned. At 811, feature extraction parameters are provided. At 813, a domain-specific feature extractor is utilized to extract features from the planning problem data structures. In some embodiments, the domain-specific feature extractor is an imaginator module. At 815, an input vector is generated using the feature extraction parameters at 811 and the domain-specific feature extractor of 813. At 821, a trained DNN model receives and applies the input vector of 815. At 825, an output vector is determined as a result of applying the trained DNN model of 821 to the input vector of 815. At 827, the output vector of 825 is decoded. In some embodiments, the decoded result is an AI action. In some embodiments, the decoded result is a PDDL action. At 829, an AI action is prepared for execution. For example, in some embodiments, the AI action is the next action to apply for solving the described problem for the described domain. In some embodiments, a parsing step is performed a single time for each domain and problem pair by the parser of 803. To determine subsequent actions, in some embodiments, the planning problem data structures of 805 are modified in runtime after the execution of the AI action of 829.

In some embodiments, the steps and components 801, 803, 805, 811, and 813 are performed and/or utilized at step 701 of FIG. 7 and the input vector of 815 is the result of performing step 701 of FIG. 7. In some embodiments, the input vector of 815 is provided as input to the trained DNN model of 821 at step 703 of FIG. 7 and the output vector of 825 is the result of performing step 703 of FIG. 7. In some embodiments, step 827 is performed at step 705 of FIG. 7 and results in the decoded AI action of 829. In some embodiments, the AI action of 829 is applied at step 707 of FIG. 7.

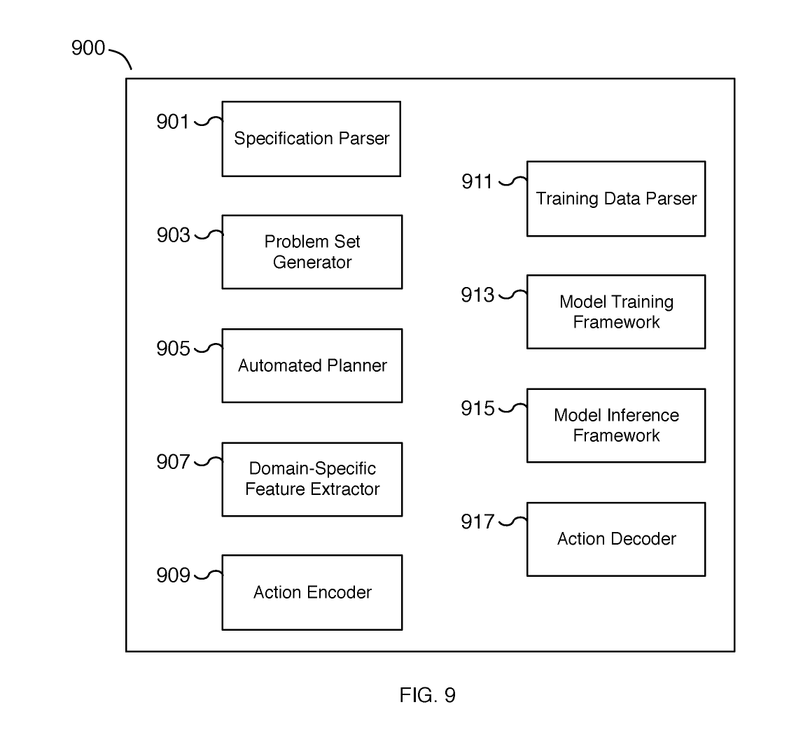

FIG. 9 is a functional diagram illustrating an embodiment of a domain-independent automated planning system using neural networks. Automated planning system 900 includes various subsystems including specification parser 901, problem-set generator 903, automated planner 905, domain-specific feature extractor 907, action encoder 909, training data parser 911, model training framework 913, model inference framework 915, and action decoder 917. In various embodiments, the functional components shown may be used to implement the processes and components of FIGS. 1-8. Additional functionality, such as connectivity between functional components is not shown. In some embodiments, the functional components may be implemented using one or more programmed computer systems. For example, the processes of FIGS. 1, 3, 5, and 7 may be performed using one or more computer processors of one or more programming computer systems. In some embodiments, various subsystems may be implemented on different programming computer systems. For example, subsystems associated with training a machine learning model may be implemented on a server and/or using a server-side implementation and the application of the trained machine learning model may be implemented on a client device or using a client-side implementation. In some embodiments, one or more subsystems may exist on both the client and server side implementations.

In some embodiments, specification parser 901 performs the step of 105 of FIG. 1 and/or 303 of FIG. 3. In some embodiments, specification parser 901 is utilized in performing the step of 701 of FIG. 7. In some embodiments, specification parser 901 is the parser of 203 of FIG. 2, 403 of FIG. 4, and/or 803 of FIG. 8. In some embodiments, problem-set generator 903 performs the step of 109 of FIG. 1 and/or is the problem-set generator of 209 of FIG. 2. In some embodiments, automated planner 905 performs the step of 321 of FIG. 3 and/or is the automated planner of 421 of FIG. 4. In some embodiments, domain-specific feature extractor 907 performs the step of 313 of FIG. 3 and/or 701 of FIG. 7. In some embodiments, domain-specific feature extractor 907 is the domain-specific feature extractor of 413 of FIG. 4 and/or 813 of FIG. 8. In some embodiments, domain-specific feature extractor 907 is implemented using an imaginator module. In some embodiments, action encoder 909 performs the step of 323 of FIG. 3 and/or 423 of FIG. 4. In some embodiments, training data parser 911 is the training data parser of 603 of FIG. 6 and may be used in performing the step of 501 of FIG. 5. In some embodiments, model training framework 913 is utilized in performing the steps of FIG. 5 and FIG. 6. In some embodiments, model training framework 913 is utilized to perform at least the steps 505, 507, and 509 of FIG. 5. In some embodiments, model training framework 913 includes the DNN training environment of 615 of FIG. 6. In some embodiments, model inference framework 915 is utilized to perform the steps of FIG. 7 and FIG. 8 and includes the trained DNN model of 821 of FIG. 8. In some embodiments, action decoder 917 performs the step of 707 of FIG. 7 and/or 827 of FIG. 8.

The automated planning system shown in FIG. 9 is but an example of a system suitable for use with the various embodiments disclosed herein. Other automated planning systems suitable for such use can include additional or fewer subsystems. Other systems having different functional configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a specification of a problem specified using an artificial intelligence planning language;
using a computer processor to determine machine learning features using the specification of the problem specified using the artificial intelligence planning language;
using the determined machine learning features and a trained machine learning model to determine a machine learning model result, wherein the machine learning model has been trained to approximate an automated planner; and
based on the machine learning model result, determining an action to perform.

2. The method of claim 1, wherein the specification of the problem specified using the artificial intelligence planning language includes a domain description and a problem description.

3. The method of claim 1, wherein the artificial intelligence planning language is a domain-independent language.

4. The method of claim 3, wherein the artificial intelligence planning language includes multi-agent extension capabilities.

5. The method of claim 1, further comprising receiving feature extraction parameters.

6. The method of claim 1, wherein determining the action to perform includes decoding the machine learning model result into an artificial intelligence planning language action.

7. The method of claim 1, wherein the action to perform is performed by a non-player character in a game.

8. The method of claim 1, wherein the trained machine learning model is trained using data created by an automated artificial intelligence planner.

9. The method of claim 1, wherein the determined machine learning features are encoded as a pixel-based image.

10. The method of claim 9, wherein the trained machine learning model receives as input the pixel-based image.

11. The method of claim 1, wherein the trained machine learning model utilizes a deep neural network.

12. The method of claim 11, wherein the deep neural network is a convolutional deep neural network.

13. A method, comprising:
receiving a specification of a domain specified using an artificial intelligence planning language;
parsing the received specification of the domain;
receiving problem-set generator parameters; and
using a computer processor to generate a plurality of problem specifications based on the parsed specification of the domain and the received problem-set generator parameters.

14. The method of claim 13, further comprising generating a training corpus for a machine learning model using the parsed specification of the domain and the generated plurality of problem specifications.

15. The method of claim 13, further comprising determining machine learning features from the generated plurality of problem specifications.

16. The method of claim 15, wherein the determined machine learning features are encoded as a pixel-based image.

17. The method of claim 13, further comprising using an automated artificial intelligence planner to generate a plurality of problem solutions based on the parsed specification of the domain and the received problem-set generator parameters.

18. The method of claim 17, wherein the generated plurality of problem solutions are utilized to train a machine learning model.

19. The method of claim 18, wherein a first action of each of the generated plurality of problem solutions is extracted and encoded.

20. The method of claim 19, wherein the first action is encoded as a one-hot vector.

21. A system, comprising:
a processor; and
a memory coupled with the processor, wherein the memory is configured to provide the processor with instructions which when executed cause the processor to:
receive a specification of a problem specified using an artificial intelligence planning language;
determine machine learning features using the specification of the problem specified using the artificial intelligence planning language;
determine a machine learning model result using the determined machine learning features and a trained machine learning model, wherein the machine learning model has been trained to approximate an automated planner; and
determine an action to perform based on the machine learning model result.
